(19) United States
(12) Patent Application Publication
(10) Pub. No.: US 2010/0113687 A1
(43) Pub. Date: May 6, 2010

(54) CURING AGENT COMPOSITIONS

(75) Inventors: Harald Schaefer, Mannheim (DE); Carl Jokisch, Mannheim (DE); Horst Binder, Lampertheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/593,295

(22) PCT Filed: Mar. 27, 2008
(86) PCT No.: PCT/EP2008/053614

§ 371 Date: Sep. 28, 2009

(30) Foreign Application Priority Data
Mar. 27, 2007 (EP) 07104971.2

(51) Int. Cl. C08G 18/12; C08G 18/70; C08L 75/06

(52) U.S. Cl. 524/590; 528/72; 528/59

(57) ABSTRACT

The present invention relates to color-stable curing agent compositions for polyurethane coating materials.

The present invention relates to color-stable curing agent compositions for polyurethane coating materials.

WO 2005/089085 describes polyisocyanate compositions as curing agents for 2K (two component) polyurethane coating materials that in addition to a catalyst for the reaction between isocyanate groups and groups reactive therewith comprises a stabilizer mixture selected from hindered phenols and secondary arylamines and also organophosphites, more particularly trialkyl phosphites. Explicitly disclosed in the examples is a polyisocyanate composition, the isocyanurate Tolonate HDT, with dibutyltin dilaurate as catalyst in butyl acetate/methyl amyl ketone/xylene 1:1:0.5.

A disadvantage of phosphites, however, particularly of trialkyl phosphites and more particularly of tributyl phosphite, is that they have a very unpleasantly reeking odor. In terms of toxicological classification, tributyl phosphite is injurious to health on contact with the skin, and corrosive. Triphenyl phosphite is irritant to eyes and skin, and highly toxic for aquatic organisms. Phosphites, moreover, are sensitive to moisture. Consequently these compounds, at least before and during incorporation into polyisocyanate compositions, represent a problem from the standpoints of health, occupational hygiene, and processing. Whereas the antioxidative action of aromatic phosphites is lower than that of their aliphatic counterparts, the availability of the aliphatic phosphites is poorer.

U.S. Pat. No. 6,376,584 B1 describes various stabilizers for use in polyurethane compositions in which polyisocyanates are reacted with polyols in the presence of dibutyltin dilaurate.

Not disclosed are the stabilization problems that arise when polyisocyanate compositions are mixed with a catalyst and stored.

U.S. Pat. No. 7,122,588 B2 describes coating materials, including polyurethane coating materials, which are stabilized with esters of hypophosphorous acid for the purpose of extending their life and against discoloration.

Not disclosed are the stabilization problems which arise when polyisocyanate compositions are mixed with a catalyst and stored. Moreover, the stabilization described therein is still not sufficient, and so there continues to be a need for improved stabilization.

EP 735027 A1 describes a process for preparing uretdiones with enhanced color quality by reacting (cyclo)aliphatic diisocyanates with catalysis by pyridine derivatives which additionally contain 0.1%-4% of trivalent phosphorus compounds of a general formula. Explicitly disclosed, however, are only phosphines, phosphites and phosphonates. Following the preparation, these phosphorus compounds are distilled off together with the unreacted isocyanate. No addition of phosphites for the purpose of stabilizing polyisocyanates is described, especially not in the presence of urethanization catalysts.

DE 19630903 describes the stabilization of isocyanates with various phosphorus compounds and phenols.

Not described in each case is the presence of catalysts for the reaction between isocyanate groups and groups reactive therewith.

It is an object of the present invention to provide further storage-stable polyisocyanate compositions which already include a catalyst for the reaction between isocyanate groups and groups reactive therewith and are color-stable, and whose stabilizers, in terms of odor, toxicology and/or moisture sensitivity, allow unproblematic occupational hygiene and health, and whose stabilizing action is at least comparable with that of the prior art. The stabilizing action ought to be independent of the origin of the monomeric isocyanate.

This object has been achieved by polyisocyanate compositions comprising
(A) at least one polyisocyanate obtainable by reacting at least one monomeric isocyanate,
(B) at least one compound able to accelerate the reaction of isocyanate groups with isocyanate-reactive groups,
(C) at least one phosphonite,
(D) optionally at least one sterically hindered phenol,
(E) optionally at least one solvent,
(F) optionally at least one acidic stabilizer,
(G) optionally other, typical coatings additives.

Polyisocyanate compositions of this kind can be reacted directly with components comprising isocyanate-reactive groups in polyurethane coating materials and feature good color stability on storage.

In one preferred embodiment the polyisocyanate compositions of the invention, after being stored for seven weeks at 50° C., exhibit not more than 30% of the increase in color number (APHA color number in accordance with DIN EN 1557) of similar polyisocyanate compositions of the prior art in which neither a component (C) nor a component (D) is present.

The monomeric isocyanates used may be aromatic, aliphatic or cycloaliphatic, preferably aliphatic or cycloaliphatic, which is referred to for short in this text as (cyclo)aliphatic; aliphatic isocyanates are particularly preferred.

Aromatic isocyanates are those which comprise at least one aromatic ring system, in other words not only purely aromatic compounds but also araliphatic compounds.

Cycloaliphatic isocyanates are those which comprise at least one cycloaliphatic ring system.

Aliphatic isocyanates are those which comprise exclusively linear or branched chains, i.e., acyclic compounds.

The monomeric isocyanates are preferably diisocyanates, which carry precisely two isocyanate groups. They can, however, in principle also be monoisocyanates, having one isocyanate group.

In principle, higher isocyanates having on average more than 2 isocyanate groups are also contemplated. Suitability therefor is possessed for example by triisocyanates, such as triisocyanatononane, 2′-isocyanatoethyl 2,6-diisocyanatohexanoate, 2,4,6-triiso-cyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates.

These monomeric isocyanates do not contain any substantial products of reaction of the isocyanate groups with themselves.

The monomeric isocyanates are preferably isocyanates having 4 to 20 C atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g., methyl 2,6-diisocyanatohexanoate or ethyl 2,6-diisocyanatohexanoate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diisocyanato-1-methylcyclohexane, and also 3 (or 4), 8 (or 9)-bis(isocyanatomethyl)tricyclo-[5.2.1.0^{2,6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diiso-cyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanato-methyl)cyclohexane, isophorone diisocyanate, and 4,4′- or 2,4′-di(isocyanato-cyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25.

Dicyclohexylmethane 4,4′-diisocyanate may likewise be in the form of a mixture of the different cis and trans isomers.

For the present invention it is possible to use not only those diisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3-isocyanatomethyl-3,55-trimethylcyclohexane (isophorone diisocyanate or IPDI) can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and in the presence, if appropriate, of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention the isocyanates used have a total hydrolyzable chlorine content of less than 200 ppm, preferably of less than 120 ppm, more preferably less than 80 ppm, very preferably less than 50 ppm, in particular less than 15 ppm, and especially less than 10 ppm. This can be measured by means, for example, of ASTM specification D4663-98. Of course, though, monomeric isocyanates having a higher chlorine content can also be used, of up to 500 ppm, for example.

It will be appreciated that it is also possible to employ mixtures of those monomeric isocyanates which have been obtained by reacting the (cyclo)aliphatic diamines with, for example, urea and alcohols and cleaving the resulting (cyclo)aliphatic biscarbamic esters, with those diisocyanates which have been obtained by phosgenating the corresponding amines.

The polyisocyanates (A) which can be formed by oligomerizing the monomeric isocyanates are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates (A) are preferably compounds as follows:
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates. The polyisocyanates containing uretdione groups are obtained in the context of this invention as a mixture with other polyisocyanates, more particularly those specified under 1). For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cyclo-aliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols (A). These polyisocyanates containing urethane and/or allophanate groups generally have an NCO content of 12% to 24% by weight and an average NCO functionality of 2.5 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as Zn(II) compounds, for example, in each case in the presence of monohydric, dihydric or polyhydric, preferably monohydric, alcohols.
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.
12) The polyisocyanates 1)-11), preferably 1), 3), 4), and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water or by reaction with amines. The formation of urethane and/or allophanate groups is accomplished by reaction with monohydric, dihydric or polyhydric, preferably monohydric, alcohols, in the presence if appropriate of suitable catalysts. These polyisocyanates containing biuret or urethane/allophanate groups generally have an NCO content of 18% to 22% by weight and an average NCO functionality of 2.8 to 6.
13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of the above molecules. The latter groups are nonionic groups such as alkylpolyethylene oxide and/or ionic groups derived from phosphoric acid, phosphonic acid, sulfuric acid or sulfonic acid, and/or their salts.
14) Modified polyisocyanates for dual cure applications, i.e., polyisocyanates which as well as the groups described under 1-13 also comprise groups resulting formally from addition of molecules containing NCO-reactive groups and UV-crosslinkable or actinic-radiation-crosslinkable groups to the isocyanate groups of the above molecules. These molecules are, for example, hydroxyalkyl (meth)acrylates and other hydroxylvinyl compounds.

The diisocyanates or polyisocyanates recited above may also be present at least partly in blocked form.

Classes of compounds used for blocking are described in D. A. Wicks, Z. W. Wicks, Progress in Organic Coatings, 36, 148-172 (1999), 41, 1-83 (2001) and also 43, 131-140 (2001).

Examples of classes of compounds used for blocking are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

In one preferred embodiment of the present invention the polyisocyanate (A) is selected from the group consisting of isocyanurates, biurets, urethanes, and allophanates, preferably from the group consisting of isocyanurates, urethanes, and allophanates, more preferably from the group consisting of isocyanurates and allophanates; in particular it is a polyisocyanate containing isocyanurate groups.

In one particularly preferred embodiment the polyisocyanate (A) encompasses polyisocyanates comprising isocyanurate groups and obtained from 1,6-hexamethylene diisocyanate.

In one further particularly preferred embodiment the polyisocyanate (A) encompasses a mixture of polyisocyanates comprising isocyanurate groups and obtained from 1,6-hexamethylene diisocyanate and from isophorone diisocyanate.

In one particularly preferred embodiment the polyisocyanate (A) is a mixture comprising low-viscosity polyisocyanates, preferably polyisocyanates comprising isocyanurate groups, having a viscosity of 600-1500 mPa*s, more particularly below 1200 mPa*s, low-viscosity urethanes and/or allophanates having a viscosity of 200-1600 mPa*s, more particularly 600-1500 mPa*s, and/or polyisocyanates comprising iminooxadiazinedione groups.

In this specification, unless noted otherwise, the viscosity is reported at 23° C. in accordance with DIN EN ISO 3219/A.3 in a cone/plate system with a shear rate of 1000 s⁻¹.

The process for preparing the polyisocyanates may take place as described in the unpublished European patent application with the application number 06125323.3 and the filing date of Dec. 4, 2006, especially from page 20 line 21 to page 27 line 15 therein, which is hereby made part of the present specification by reference.

The reaction can be discontinued, for example, as described therein from page 31 line 19 to page 31 line 31, and working up may take place as described therein from page 31 line 33 to page 32 line 40, which in each case is hereby made part of the present specification by reference.

The reaction can alternatively be discontinued as described in WO 2005/087828 from page 11 line 12 to page 12 line 5, which is hereby made part of the present specification by reference.

In the case of thermally labile catalysts it is also possible, furthermore, to discontinue the reaction by heating the reaction mixture to a temperature above at least 80° C., preferably at least 100° C., more preferably at least 120° C. Generally it is sufficient for this purpose to heat the reaction mixture, in the way which is necessary at the working-up stage in order to separate the unreacted isocyanate, by distillation.

In the case both of thermally non-labile catalysts and of thermally labile catalysts, the possibility exists of terminating the reaction at relatively low temperatures by addition of deactivators. Examples of suitable deactivators are hydrogen chloride, phosphoric acid, organic phosphates, such as dibutyl phosphate or diethylhexyl phosphate, carbamates such as hydroxyalkyl carbamate, or organic carboxylic acids.

These compounds are added neat or diluted in a suitable concentration as necessary to discontinue the reaction.

Compounds (B), which are able to accelerate the reaction of isocyanate groups with isocyanate-reactive groups, are those compounds which, by their presence in a reactant mixture, result in a higher fraction of reaction products containing urethane groups than does the same reactant mixture in their absence, under the same reaction conditions.

These compounds (B) are known from the literature, as for example from G. Oertel (Ed.), Polyurethane, 3rd edition 1993, Carl Hanser Verlag, Munich Vienna, pages 104 to 110, section 3.4.1. “Catalysts”, preference being given to organic amines, especially tertiary aliphatic, cycloaliphatic or aromatic amines, Brønsted acids and/or Lewis-acidic organometallic compounds; Lewis-acidic organometallic compounds are particularly preferred.

Examples of suitable Lewis-acidic organic metal compounds are tin compounds, such as tin(II) salts of organic carboxylic acids, e.g., tin(II) diacetate, tin(II) dioctoate, tin(II) bis(ethylhexanoate), and tin(II) dilaurate, and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. In addition it is possible to use zinc(II) salts, such as zinc(II) dioctoate, for example.

Unless indicated otherwise, the carboxylic acids in question, in the case of octoate, for example, can be branched and/or unbranched isomers, preferably unbranched.

Also possible are metal complexes such as acetylacetonates of iron, of titanium, of aluminum, of zirconium, of manganese, of nickel, of zinc, and of cobalt.

Further metal catalysts are described by Blank et al. in Progress in Organic Coatings, 1999, vol. 35, pages 19-29.

Tin-free and zinc-free alternatives used include zirconium, bismuth, and aluminum compounds. These are, for example, zirconium tetraacetylacetonate (e.g., K-KAT® 4205 from King Industries); zirconium dionates (e.g., K-KAT® XC-9213; XC-A 209 and XC-6212 from King Industries); bismuth compounds, especially tricarboxylates (e.g., K-KAT® 348, XC-B221; XC-C227, XC 8203 from King Industries); aluminum dionate (e.g., K-KAT® 5218 from King Industries). Tin-free and zinc-free catalysts are otherwise also offered, for example, under the trade name Borchi® Kat from Borchers, TK from Goldschmidt or BICAT® from Shepherd, Lausanne.

These catalysts are suitable for solvent-based, water-based and/or blocked systems.

Molybdenum, tungsten and vanadium catalysts are described more particularly for the reaction of blocked polyisocyanates in WO 2004/076519 and WO 2004/076520.

Cesium salts as well can be used as catalysts. Suitable cesium salts are those compounds in which the following anions are employed: F—, Cl—, CIO—, CIO₃—, CIO₄—, Br—, I—, IO₃—, CN—, OCN—, NO₂—, NO₃—, HCO₃—, CO₃²⁻, S²⁻, SH—, HSO₃—, SO₃²⁻, HSO₄—, SO₄²⁻, S₂O₂²⁻, S₂O₄²⁻, S₂O₅²⁻, S₂O₆²⁻, S₂O₇²⁻, S₂O₈²⁻, H₂PO₂—, H₂PO₄—, HPO₄²⁻, PO₄³—, P₂O₇⁴—, (OCₙH₂ₙ₊₁)—, (CₙH₂ₙ₋₁O₂)—, (CₙH₂ₙ₋₃O₂)—, and also (Cₙ₊₁H₂ₙ₋₁O₂)²⁻, where n stands for the numbers 1 to 20.

Preferred here are cesium carboxylates in which the anion conforms to the formulae (OCₙH₂ₙ₋₁)— and also (Cₙ₊₁H₂ₙ₋₂O₂)²⁻, with n being 1 to 20. Particularly preferred cesium salts contain monocarboxylate anions of the general formula (OCₙH₂ₙ₊₁)—, with n standing for the numbers 1 to 20. Particular mention in this context is deserved by formate, acetate, propionate, hexanoate, and 2-ethylhexanoate.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zinc(II) dioctoate, zirconium acetylacetonate, and zirconium 2,2,6,6-tetramethyl-3,5-heptanedionate.

Particular preference, however, is given to dibutyltin dilaurate.

Phosphonites (C) are compounds which meet the formula

P(OR¹)(OR²)(R³),

in which

R¹, R², and R³ each independently can be C₁-C₁₈ alkyl, C₆-C₁₂ aryl, and C₅-C₁₂-cycloalkyl, it being possible for each of the stated radicals to be substituted by aryl, alkyl, aryloxy, alkyloxy, heteroatoms and/or heterocycles.

The phosphites in question may be monocyclic or polycyclic, aliphatically, cycloaliphatically and/or aromatically substituted phosphonites.

By “polycyclic” phosphonites are meant those which within one molecule carry two or more phosphonite groups, i.e., singularly, organically substituted phosphorus atoms which in turn carry two organically substituted oxygen atoms.

In these definitions

C₁-C₁₈ alkyl unsubstituted or substituted by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl;

C₆-C₁₂ aryl unsubstituted or substituted by aryl, alkyl, aryloxy, alkyloxy, heteroatoms and/or heterocycles is for example phenyl, tolyl, xylyl, α-naphthyl, β-naphthyl, 4-biphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl; and C₅-C₁₂ cycloalkyl unsubstituted or substituted by aryl, alkyl, aryloxy, alkyloxy, heteroatoms and/or heterocycles is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, and a saturated or unsaturated bicyclic system such as norbornyl or norbornenyl, for example.

Preferred radicals R¹ and R² are C₆-C₁₂ aryl unsubstituted or substituted by aryl, alkyl, aryloxy, alkyloxy, heteroatoms and/or heterocycles, more particularly phenyl or sterically hindered aryl.

The term “sterically hindered” in the context of this specification means that at least one and preferably both ortho-positions relative to the functional group carry a tert-butyl group.

Preferred radicals R³ are C₆-C₁₂ aryl unsubstituted or substituted by aryl, alkyl, aryloxy, alkyloxy, heteroatoms and/or heterocycles, more particularly phenyl and p-tolyl.

Examples of other compounds of this type and also corresponding bis-thio compounds are found in U.S. Pat. No. 4,075,163, hereby made part of the present specification by reference.

For the case of a dinuclear phosphonite it is preferred for the phosphonite groups to be connected to one another via a 4,4′-biphenylene unit.

Preference is given to the compound tetrakis(2,4-di-tert-butylphenyl)-4,4′-diphenylene diphosphonite [CAS No. 119345-01-6], which is available commercially, for example, under the trade name Irgafos® P-EPQ from Ciba Spezialitätenchemie and Hostanox® P-EPQ from Clariant, and which has the following structural formula (where R═H):

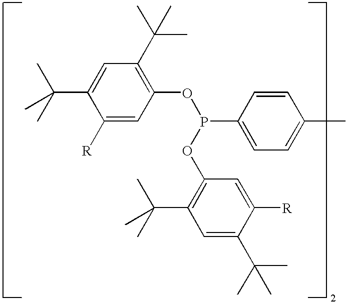

Tetrakis(2,4-di-tert-butylphenyl)-4,4′-diphenylene diphosphonite is readily available industrially and is used as an antioxidant for thermoplastics.

Tetrakis(2,4-di-tert-butylphenyl)-4,4′-diphenylene diphosphonite is highly soluble in organic solvents. As a result of its preparation, however, it comprises chlorine-containing secondary components, which can lead to hazing. These chlorine-containing secondary components can be extracted very largely by means, for example, of extraction of these compounds with water from an organic solution, as for example with hexane or methylene chloride against water or saturated sodium chloride solution, and can subsequently be dried, for example, over magnesium sulfate.

Such purified forms of this compound are especially preferred for the process of the invention, since hazing in the polyisocyanate compositions of the invention or in the completed coating materials is unwanted.

Preference is also given to the compound tetrakis(2,4-di-tert-butyl-5-methylphenyl)[1,1-biphenyl]-4,4′-diylbisphosphonite (or alternatively tetrakis(2,4-di-tert-butyl-5-methylphenyl) 4,4′-diphenylene diphosphonite), which is sold under the trade name GSY-P 101 by API Corporation or Yoshitomi, and has the above structural formula with R=methyl.

The two last-mentioned compounds are toxicologically unproblematic, are stable to hydrolysis and are almost odorless as compared with phosphites, and consequently are advantageous from the standpoints of health and occupational hygiene.

The phosphonite in this invention functions primarily as a secondary antioxidant. These are typically understood by the skilled worker to be compounds which prevent the formation of free radicals, more particularly by scavenging and/or breaking down peroxides.

Optionally it is possible for at least one phenol to be present, preferably at least one sterically hindered phenol (D); with preference there is at least one, more preferably just one, phenol (D) present. Phenols in the sense of the invention have the function of a primary antioxidant. This is typically understood by the skilled worker to refer to compounds which scavenge free radicals.

Examples of phenols are alkylphenols, for example, o-, m- or p-cresol (methylphenol), 2-tert-butyl-4-methylphenol, 6-tert-butyl-2,4-dimethylphenol, 2,6-di-tert-butyl-4-methylphenol, 2-tert-butylphenol, 4-tert-butylphenol, 2,4-di-tert-butylphenol, 2-methyl-4-tert-butylphenol, 4-tert-butyl-2,6-dimethylphenol, or 2,2′-methylenebis(6-tert-butyl-4-methylphenol), 4,4′-oxydiphenyl, 3,4-methylenedioxydiphenol (sesamol), 3,4-dimethylphenol, hydroquinone, pyrocatechol (1,2-dihydroxybenzene), 2-(1′-methylcyclohex-1′-yl)-4,6-dimethylphenol, 2- or 4-(1′-phenyleth-1′-yl)phenol, 2-tert-butyl-6-methylphenol, 2,4,6-tris-tert-butylphenol, 2,6-di-tert-butylphenol, 2,4-di-tert-butylphenol, 4-tert-butylphenol, nonylphenol [11066-49-2], octylphenol [140-66-9], 2,6-dimethylphenol, bisphenol A, bisphenol F, bisphenol B, bisphenol C, bisphenol S, 3,3′,5,5′-tetrabromobisphenol A, 2,6-di-tert-butyl-p-cresol, Koresin® from BASF AG, methyl 3,5-di-tert-butyl-4-hydroxybenzoate, 4-tert-butylpyrocatechol, 2-hydroxybenzyl alcohol, 2-methoxy-4-methylphenol, 2,3,6-trimethylphenol, 2,4,5-trimethylphenol, 2,4,6-trimethylphenol, 2-isopropylphenol, 4-isopropylphenol, 6-isopropyl-m-cresol, n-octadecyl β-(3,5-di-tert-butyl-4-hydroxyphenyl)propionate, 1,1,3-tris-(2-methyl-4-hydroxy-5-tert-butylphenyl)butane, 1,3,5-trimethyl-2,4,6-tris(3,5-di-tert-butyl-4-hydroxybenzyl)benzene, 1,3,5-tris-(3,5-di-tert-butyl-4-hydroxybenzyl) isocyanurate, 1,3,5-tris-(3,5-di-tert-butyl-4-hydroxyphenyl)propionyloxyethyl isocyanurate, 1,3,5-tris-(2,6-dimethyl-3-hydroxy-4-tert-butylbenzyl)isocyanurate or pentaerythritol tetrakis[β-(3,5-di-tert-butyl-4-hydroxyphenyl)propionate], 2,6-di-tert-butyl-4-dimethylaminomethyl-phenol, 6-isobutyl-2,4-dinitrophenol, 6-sec-butyl-2,4-dinitrophenol, Irganox® 565, 1141, 1192, 1222 and 1425 from Ciba Spezialitätenchemie, octadecyl 3-(3′,5′-di-tert-butyl-4′-hydroxyphenyl)propionate, hexadecyl 3-(3′,5′-di-tert-butyl-4′-hydroxyphenyl)propionate, octyl 3-(3′,5′-di-tert-butyl-4′-hydroxyphenyl)propionate, 3-thia-1,5-pentanediol bis[(3′,5′-di-tert-butyl-4′-hydroxyphenyl)propionate], 4,8-dioxa-1,1′-undecanediol bis[(3′,5′-di-tert-butyl-4′-hydroxyphenyl)propionate], 4,8-dioxa-1,1′-undecanediol bis[(3′-tert-butyl-4′-hydroxy-5′-methylphenyl)propionate], 1,9-nonanediol bis[(3′,5′-di-tert-butyl-4′-hydroxyphenyl)propionate], 1,7-heptanediaminebis[3-(3′,5′-di-tert-butyl-4′-hydroxyphenyl)propionamide], 1,1-methanediaminebis[3-(3′,5′-di-tert-butyl-4′-hydroxyphenyl)propionamide], 3-(3′,5′-di-tert-butyl-4′-hydroxyphenyl)propionoic hydrazide, 3-(3′,5′-dimethyl-4′-hydroxyphenyl)propionoic hydrazide, bis(3-tert-butyl-5-ethyl-2-hydroxyphen-1-yl)methane, bis(3,5-di-tert-butyl-4-hydroxyphen-1-yl)methane, bis[3-(t-methylcyclohex-1′-yl)-5-methyl-2-hydroxyphen-1-yl]methane, bis(3-tert-butyl-2-hydroxy-5-methylphen-1-Amethane, 1,1-bis(5-tert-butyl-4-hydroxy-2-methylphen-1-yl)ethane, bis(5-tert-butyl-4-hydroxy-2-methylphen-1-yl) sulfide, bis(3-tert-butyl-2-hydroxy-5-methylphen-1-yl) sulfide, 1,1-bis(3,4-dimethyl-2-hydroxyphen-1-yl)-2-methylpropane, 1,1-bis(5-tert-butyl-3-methyl-2-hydroxyphen-1-yl)butane, 1,3,5-tris[1′-(3″,5″-di-tert-butyl-4″-hydroxyphen-1″-yl)-meth-1′-yl]-2,4,6-trimethylbenzene, 1,1,4-tris(5′-tert-butyl-4′-hydroxy-2′-methylphen-1′-yl)butane, aminophenols, such as para-aminophenol, 3-diethylaminophenol, nitrosophenols, such as para-nitrosophenol, p-nitroso-o-cresol, alkoxyphenols, such as 2-methoxyphenol (Guajacol, pyrocatechol monomethyl ether), 2-ethoxyphenol, 2-isopropoxyphenol, 4-methoxyphenol (hydroquinone monomethyl ether), mono- or di-tert-butyl-4-methoxyphenol, 3,5-di-tert-butyl-4-hydroxyanisole, 3-hydroxy-4-methoxybenzyl alcohol, 2,5-dimethoxy-4-hydroxybenzyl alcohol (syringa alcohol), 4-hydroxy-3-methoxybenzaldehyde (vanillin), 4-hydroxy-3-ethoxybenzaldehyde (ethyl vanillin), 3-hydroxy-4-methoxybenzaldehyde (isovanillin), 1-(4-hydroxy-3-methoxyphenyl)ethanone (acetovanillin), eugenol, dihydroeugenol, isoeugenol, tocopherols, such as α-, β-, γ-, δ- and ε-tocopherol, tocol, α-tocopherolhydroquinone, hydroquinone or hydroquinone monomethyl ether, 2,5-di-tert-butylhydroquinone, 2-methyl-p-hydroquinone, 2,3-dimethylhydroquinone, trimethylhydroquinone, 4-methylpyrocatechol, tert-butylhydroquinone, 3-methylpyrocatechol, 2-methyl-p-hydroquinone, 2,3-dimethylhydroquinone, trimethylhydroquinone, 3-methylpyrocatechol, 4-methylpyrocatechol, tert-butylhydroquinone, 4-ethoxyphenol, 4-butoxyphenol, hydroquinone monobenzyl ether, p-phenoxyphenol, 2-methylhydroquinone, 2,5-di-tert-butylhydroquinone, 2,5-di-tert-amylhydroquinone, 2,3-dihydro-2,2-dimethyl-7-hydroxybenzofuran (2,2-dimethyl-7-hydroxycoumaran), 6-hydroxy-2,5,7,8-tetramethylchroman-2-carboxylic acid (Trolox®), and derivatives thereof.

The compounds in question are preferably phenols which on the aromatic ring have just one phenolic hydroxy group, and more preferably those which in ortho-position, very preferably in ortho- and para-position to the phenolic hydroxy group, have any desired substituent, preferably an alkyl group.

Phenols of this kind may also be parts of a polyphenolic system having two or more phenol groups, such as pentaerythritol tetrakis[β-(3,5-di-tert-butyl-4-hydroxyphenyl)propionate] (e.g., Irganox® 1010), Irganox® 1330, 1,3,5-tris(3,5-di-tert-butyl-4-hydroxybenzyl)-1,3,5-triazine-2,4,6(1H,3H,5H)trione (e.g., Irganox® 3114), each products of Ciba Spezialitätenchemie.

Corresponding products are available, for example, under the trade names Irganox® (Ciba Spezialitätenchemie), Sumilizer® from Sumitomo, Lowinox® from Great Lakes, and Cyanox® from Cytec.

Also conceivable are, for example, thiodiethylenebis[3-[3,5-di-tert-butyl-4-hydroxyphenyl]propionate] (Irganox® 1035) and 6,6′-di-tert-butyl-2,2′-thiodi-p-cresol (e.g., Irganox® 1081), each products of Ciba Spezialitätenchemie.

It is possible as well, furthermore, optionally for a solvent or solvent mixture (E) to be present.

Solvents which can be used are those which contain no groups that are reactive toward isocyanate groups or blocked isocyanate groups, and in which the polyisocyanates are soluble to an extent of at least 10%, preferably at least 25%, more preferably at least 50%, very preferably at least 75%, more particularly at least 90%, and especially at least 95% by weight.

Examples of solvents of this kind are aromatic hydrocarbons (including alkylated benzenes and naphthalenes) and/or (cyclo)aliphatic hydrocarbons and mixtures thereof, chlorinated hydrocarbons, ketones, esters, alkoxylated alkyl alkanoates, ethers, and mixtures of the solvents.

Preferred aromatic hydrocarbon mixtures are those which comprise predominantly aromatic C₇- to C₁₄ hydrocarbons and may encompass a boiling range from 110 to 300° C.; particular preference is given to toluene, o-, m- or p-xylene, trimethylbenzene isomeres, tetramethylbenzene isomers, ethylbenzene, cumene, tetrahydronaphthalene and mixtures comprising them.

Examples thereof are the Solvesso® products from Exxon Mobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® products from Shell, Caromax® (e.g., Caromax® 18) from Petrochem Carless and Hydrosol from DHC (e.g., as Hydrosol® A 170). Hydrocarbon mixtures comprising paraffins, cycloparaffins, and aromatics are also available commercially under the names Kristalloel (for example, Kristalloel 30, boiling range about 158-198° C. or Kristalloel 60: CAS No. 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally more than 90%, preferably more than 95%, more preferably more than 98%, and very preferably more than 99% by weight. It may be advisable to use hydrocarbon mixtures having a particularly reduced naphthalene content.

Examples of (cyclo)aliphatic hydrocarbons include decalin, alkylated decalin, and isomer mixtures of linear or branched alkanes and/or cycloalkanes.

The amount of aliphatic hydrocarbons is generally less than 5%, preferably less than 2.5%, and more preferably less than 1% by weight.

Esters are, for example, n-butyl acetate, ethyl acetate, 1-methoxyprop-2-yl acetate, and 2-methoxyethyl acetate.

Ethers are, for example, THF, dioxane, and also the dimethyl, diethyl or di-n-butyl ethers of ethylene glycol, diethylene glycol, triethylene glycol, propylene glycol, dipropylene glycol or tripropylene glycol.

Ketones are, for example, acetone, diethyl ketone, ethyl methyl ketone, isobutyl methyl ketone, methyl amyl ketone and tert-butyl methyl ketone.

Surprisingly it has been found that the solvents are differently problematic in relation to the stated object. Polyisocyanate compositions as per the patent which comprise ketones or mixtures of aromatics (solvent naphtha mixtures, for example) are particularly critical in respect of development of color number on storage. In contrast, esters, ethers, and certain aromatics such as xylene or its isomer mixtures are less problematic. This is surprising insofar as xylenes, in the same way as the mixtures of aromatics, likewise carry benzylic hydrogen atoms, which could play a part in the development of color. A further factor is that solvent naphtha mixtures, depending on the source and storage time, can have significantly different effects on color number drift if used in the polyisocyanate compositions.

Optionally it is also possible in addition for a further stabilizing compound to be added in the form of at least one, preferably just one, acidic stabilizer (F). The compounds in question are Brønsted acids.

Those suitable include organic monocarboxylic acids and/or organic carboxylic acids, examples being linear or branched, aliphatic monocarboxylic acids having 1 to 12 C atoms, preferably 1 to 8 C atoms, which optionally may be substituted by halogen atoms, preferably chlorine atoms and/or alkoxy groups having from 1 to 12 C atoms, preferably 1 to 6 C atoms, more particularly methoxy and/or ethoxy groups, such as, for example, formic acid, acetic acid, propionic acid, 2,2-dimethylpropionic acid, butyric acid, isobutyric acid, 2-methoxybutyric acid, n-valeric acid, chloroacetic acid, capronoic acid, 2-ethylhexanoic acid, n-heptylic acid, n-octylic acid, caprylic acid, and pelargonic acid, aromatic monocarboxylic acids having 6 to 12 C atoms, such as benzoic acid, toluic acid, and napthenic acid, aliphatic polycarboxylic acid having 2 to 12 C atoms, preferably 4 to 6 C atoms, such as oxalic acid, succinic acid, maleic acid, fumaric acid, 2-ethylsuccinic acid, glutaric acid, 2-methylglutaric acid, adipic acid, 2-methyladipic and 2,2-dimethyladipic acid, 1,8-octanoic acid, 1,10-decanoic acid, and 1,12-dodecanoic acid, for example, aromatic dicarboxylic acids having 8 to 12 C atoms, such as phthalic acid, terephthalic acid, and isophthalic acid, for example, carboxylic chlorides, examples being aliphatic and aromatic monocarboxylic chlorides, carboxylic monochlorides and dichlorides of aliphatic and aromatic polycarboxylic acids, preferably dicarboxylic acids, inorganic acids, such as phosphoric acid, phosphorous acid, and hydrochloric acid, and diesters, examples being the alkyl and/or aryl diesters of phosphoric acid and/or phosphorous acid or inorganic acid chlorides such as phosphorus oxychloride or thionyl chloride, for example. The acidic stabilizers may be used individually or in the form of a mixture of at least two acidic stabilizers.

As acidic stabilizers it is preferred to use aliphatic monocarboxylic acids and 1 to 8 C atoms, such as formic acid and acetic acid, for example, aliphatic dicarboxylic acids having 2 to 6 C atoms, such as oxalic acid, for example, and more particularly 2-ethylhexanoic acid, chloropropionoic acid and/or methoxy acetic acid.

Further, typical coatings additives (G) used may be the following, for example: other antioxidants such as phosphites of the type P(OR^{a})(OR^{b})(OR^{c}) with R^{a}, R^{b}, and R^{c} being identical or different aliphatic or aromatic radicals (which may also form cyclic structures or spiro structures), UV stabilizers such as UV absorbers and suitable free-radical scavengers (especially HALS compounds, hindered amine light stabilizers), activators (accelerators), drying agents, fillers, pigments, dyes, antistatic agents, flame retardants, thickeners, thixotropic agents, surface-active agents, viscosity modifiers, plasticizers or chelating agents. UV stabilizers are preferred.

Suitable UV absorbers comprise oxanilides, triazines and benzotriazole (the latter available, for example, as Tinuvin® products from Ciba Spezialitätenchemie) and benzophenones (e.g., Chimassorb® 81 from Ciba Spezialitätenchemie). Preference is given, for example, to 95% benzenepropanoic acid, 3-(2H-benzotriazol-2-yl)-5-(1,1-dimethylethyl)-4-hydroxy-, C7-9-branched and linear alkyl esters; 5% 1-methoxy-2-propyl acetate (e.g., Tinuvin® 384) and α-[3-[3-(2H-benzotriazol-2-yl)-5-(1,1-dimethylethyl)-4-hydroxyphenyl]-1-oxopropyl]-ω-hydroxypoly(oxo-1,2-ethanediyl) (e.g., Tinuvin® 1130), in each case products, for example, of Ciba Spezialitätenchemie. DL-alpha-tocopherol, tocopherol, cinnamic acid derivatives, and cyanoacrylates can likewise be used for this purpose.

These can be employed alone or together with suitable free-radical scavengers, examples being sterically hindered amines (often also identified as HALS or HAS compounds; hindered amine (light) stabilizers) such as 2,2,6,6-tetramethylpiperidine, 2,6-di-tert-butylpiperidine or derivatives thereof, e.g., bis(2,2,6,6-tetramethyl-4-piperidyl) sebacate. They are obtainable, for example, as Tinuvin® products and Chimassorb® products from Ciba Spezialitätenchemie. Preference in joint use with Lewis acids, however, is given to those hindered amines which are N-alkylated, examples being bis(1,2,2,6,6-pentamethyl-4-piperidinyl) [[3,5-bis(1,1-dimethylethyl)-4-hydroxyphenyl]methyl]butylmalonate (e.g., Tinuvin® 144 from Ciba Spezialitätenchemie); a mixture of bis(1,2,2,6,6-pentamethyl-4-piperidinyl)sebacate and methyl(1,2,2,6,6-pentamethyl-4-piperidinyl) sebacate (e.g., Tinuvin® 292 from Ciba Spezialitätenchemie); or which are N—(O-alkylated), such as, for example, decanedioic acid, bis(2,2,6,6-tetramethyl-1-(octyloxy)-4-piperidinyl) ester, reaction products with 1,1-dimethylethyl hydroperoxide and octane (e.g., Tinuvin® 123 from Ciba Spezialitätenchemie).

UV stabilizers are used typically in amounts of 0.1% to 5.0% by weight, based on the solid components present in the preparation.

Suitable thickeners include, in addition to free-radically (co)polymerized (co)polymers, typical organic and inorganic thickeners such as hydroxymethylcellulose or bentonite.

Chelating agents which can be used include, for example, ethylenediamineacetic acid and salts thereof and also β-diketones.

As component (H) in addition it is possible for fillers, dyes and/or pigments to be present.

Pigments in the true sense are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments in the true sense comprise any desired systems of absorption pigments and/or effect pigments, preferably absorption pigments. There are no restrictions whatsoever on the number and selection of the pigment components. They may be adapted as desired to the particular requirements, such as the desired perceived color, for example, as described in step a), for example. It is possible for example for the basis to be all the pigment components of a standardized mixer system.

Effect pigments are all pigments which exhibit a platelet-shaped construction and give a surface coating specific decorative color effects. The effect pigments are, for example, all of the pigments which impart effect and can be used typically in vehicle finishing and industrial coatings. Examples of such effect pigments are pure metallic pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, typical organic or inorganic absorption pigments that can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants, and differ from the pigments in their solubility in the application medium; i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes may find application as basic or cationic dyes, mordant dyes, direct dyes, disperse dyes, development dyes, vat dyes, metal complex dyes, reactive dyes, acid dyes, sulfur dyes, coupling dyes or substantive dyes.

Coloristically inert fillers are all substances/compounds which on the one hand are coloristically inactive, i.e., exhibit a low intrinsic absorption and have a refractive index similar to that of the coating medium, and which on the other hand are capable of influencing the orientation (parallel alignment) of the effect pigments in the surface coating, i.e., in the applied coating film, and also properties of the coating or of the coating compositions, such as hardness or rheology, for example. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, of glass, ceramic or polymers, with sizes of 0.1-50 μm, for example. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Preferred fillers comprise silicates, examples being silicates obtainable by hydrolysis of silicon tetrachloride, such as Aerosil® from Degussa, siliceous earth, talc, aluminum silicates, magnesium silicates, calcium carbonates, etc.

In one preferred form, polyisocyanates (A) are made available for further processing in a first step in a blend with phosphonite (C), optionally hindered phenol (D), optionally solvent(s) (E), optionally acidic stabilizer (F), and optionally additives (G). The amount of polyisocyanate in this case is typically more than 50%, in particular 65-99.99% by weight. These mixtures are then converted, in a second step, into the polyisocyanate compositions of the invention, by addition of—where appropriate—further of components (B) to (G), and also, optionally, (H).

Preferred solvents for premixes of this first step are n-butyl acetate, ethyl acetate, 1-methoxyprop-2-yl acetate, 2-methoxyethyl acetate, and mixtures thereof, especially with the aromatic hydrocarbon mixtures set out above.

Mixtures of this kind can be produced in a volume ratio of 5:1 to 1:5, preferably in a volume ratio of 4:1 to 1:4, more preferably in a volume ratio of 3:1 to 1:3, and very preferably in a volume ratio of 2:1 to 1:2.

Preferred examples are butyl acetate/xylene, methoxypropyl acetate/xylene 1:1, butyl acetate/solvent naphtha 100 1:1, butyl acetate/Solvesso® 100 1:2 and Kristalloel 30/Shellsol® A 3:1.

The constitution of the polyisocyanate compositions of the invention is for example as follows:

(A) 20% to 99.998%, preferably 30% to 90%, more preferably 40-80% by weight,
(B) 10 to 10 000 ppm, preferably 20 to 5000 ppm, more preferably 30 to 2000 ppm, and very preferably 50 to 1000 ppm by weight,
(C) 10 to 5000 ppm, preferably 20 to 2000 ppm, more preferably 50 to 1000 ppm, and very preferably 100 to 1000 ppm by weight,
(D) 0 to 5000 ppm, preferably 10 to 2000 ppm, more preferably 20 to 600 ppm, and very preferably 50 to 200 ppm by weight, and
(E) 0% to 80%, preferably 10-70%, more preferably 20% to 60% by weight,
(F) 0-5000 ppm, preferably 20 to 500 ppm by weight,
(G)0-5% additives,
with the proviso that the sum always makes 100% by weight.

Where components (H) are present, they are not included in the composition of components (A) to (G).

The polyisocyanate compositions of the invention can be used with advantage as curing agent components additionally to at least one binder in polyurethane coating materials.

The reaction with binders may take place, where appropriate, after a long period of time, necessitating storage of the polyisocyanate composition accordingly. Although polyisocyanate composition is stored preferably at room temperature, it can also be stored at higher temperatures. In industry, heating of such polyisocyanate compositions to 40° C., 60° C. and even up to 80° C. is entirely possible.

The binders may be, for example, polyacrylate polyols, polyester polyols, polyether polyols, polyurethane polyols; polyurea polyols; polyester-polyacrylate polyols; polyester-polyurethane polyols; polyurethane-polyacrylate polyols, polyurethane-modified alkyd resins; fatty acid-modified polyester-polyurethane polyols, copolymers with allyl ethers, graft polymers of the stated groups of compound having, for example, different glass transition temperatures, and also mixtures of the stated binders. Preference is given to polyacrylate polyols, polyester polyols, and polyether polyols.

Preferred OH numbers, measured in accordance with DIN 53240-2, are 40-350 mg KOH/g resin solids for polyesters, preferably 80-180 mg KOH/g resin solids, and 15-250 mg KOH/g resin solids for polyacrylateols, preferably 80-160 mg KOH/g.

Additionally the binders may have an acid number in accordance with DIN EN ISO 3682 of up to 200 mg KOH/g, preferably up to 150 and more preferably up to 100 mg KOH/g.

Polyacrylate polyols preferably have a molecular weight Mₙ of at least 1000, more preferably at least 2000, and very preferably at least 5000 g/mol. The molecular weight Mₙ, may in principle have no upper limit, and may preferably be up to 200 000, more preferably up to 100 000, and very preferably up to 50 000 g/mol.

The latter may be, for example, monoesters of α,β-unsaturated carboxylic acids, such as acrylic acid, methacrylic acid (identified for short in this specification as “(meth)acrylic acid”), with diols or polyols which have preferably 2 to 20 C atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, neopentyl glycol hydroxypivalate, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3- and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, polyTHF with a molar weight between 162 and 4500, preferably 250 to 2000, poly-1,3-propanediol or polypropylene glycol with a molar weight between 134 and 2000, or polyethylene glycol with a molar weight between 238 and 2000.

Preference is given to 2-hydroxyethyl acrylate, 2-hydroxyethyl methacrylate, 2- or 3-hydroxypropyl acrylate, 1,4-butanediol monoacrylate or 3-(acryloyloxy)-2-hydroxypropyl acrylate, and particular preference to 2-hydroxyethyl acrylate and/or 2-hydroxyethyl methacrylate.

The hydroxyl-bearing monomers are used in the copolymerization in a mixture of other polymerizable monomers, preferably free-radically polymerizable monomers, preferably those composed to an extent of more than 50% by weight of C₁-C₂₀, preferably C₁ to C₄ alkyl (meth)acrylate, (meth)acrylic acid, vinylaromatics having up to 20 C atoms, vinyl esters of carboxylic acids comprising up to 20 C atoms, vinyl halides, nonaromatic hydrocarbons having 4 to 8 C atoms and 1 or 2 double bonds, unsaturated nitriles, and mixtures thereof. Particular preference is given to the polymers composed to an extent of more than 60% by weight of C₁-C₁₀ alkyl (meth)acrylates, styrene and its derivatives, vinylimidazol or mixtures thereof.

In addition the polymers may contain hydroxy-functional monomers corresponding to the above hydroxyl group content and, if desired, further monomers, examples being (meth)acrylic acid glycidyl epoxy esters, ethylenically unsaturated acids, more particularly carboxylic acids, acid anhydrides or acid amides.

Further polymers are, for example, polyesterols, as are obtainable by condensing polycarboxylic acids, especially dicarboxylic acids, with polyols, especially diols. In order to ensure a polyester polyol functionality that is appropriate for the polymerization, use is also made in part of triols, tetrols, etc, and also triacids etc.

Polyester polyols are known for example from Ullmanns Encyklopädie der technischen Chemie, 4th edition, volume 19, pp. 62 to 65. It is preferred to use polyester polyols which are obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, aromatic or heterocyclic and may if appropriate be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are employed. Preference is given to dicarboxylic acids of the general formula HOOC—(CH₂)_{y}—COOH, where y is a number from 1 to 20, preferably an even number from 2 to 20, and more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, Poly-THF having a molar mass of between 162 and 4500, preferably 250 to 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if appropriate may have been alkoxylated as described above.

Preferred alcohols are those of the general formula HO—(CH₂)ₓ—OH, where x is a number from 1 to 20, preferably an even number from 2 to 20. Preferred are ethylene glycol, butane-1,4-diol, hexane-1,6-diol, octane-1,8-diol and dodecane-1,12-diol. Additionally preferred is neopentyl glycol.

Also suitable, furthermore, are polycarbonate diols of the kind obtainable, for example, by reacting phosgene with an excess of the low molecular mass alcohols specified as synthesis components for the polyester polyols.

Also suitable are lactone-based polyester diols, which are homopolymers or copolymers of lactones, preferably hydroxy-terminated adducts of lactones with suitable difunctional starter molecules. Suitable lactones are preferably those which derive from compounds of the general formula HO—(CH₂)_{z}—COOH, where z is a number from 1 to 20 and where one H atom of a methylene unit may also have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components include the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxycarboxylic acids corresponding to the lactones.

Also suitable as polymers, furthermore, are polyetherols, which are prepared by addition reaction of ethylene oxide, propylene oxide or butylene oxide with H-active components. Polycondensates of butanediol are also suitable.

In addition it is possible to use hydroxy-functional carboxylic acids, such as dimethylolpropionic acid or dimethylolbutanoic acid, for example.

The polymers can of course also be compounds containing primary or secondary amino groups.

For this purpose, polyisocyanate composition and binder are mixed with one another in a molar ratio of isocyanate groups to isocyanate-reactive groups of 0.1:1 to 10:1, preferably 0.2:1 to 5:1, more preferably 0.3:1 to 3:1, very preferably 0.5:1 to 2:1, more particularly 0.8:1 to 1.2:1, and especially 0.9:1 to 1.1:1, it being possible if desired to mix in further, typical coatings constituents, and the resulting mixture is applied to the substrate.

Subsequently the coating-material mixture is cured at ambient temperature to 140° C., preferably 20 to 80° C., more preferably up to 60° C.

Depending on temperature, this usually takes not more than 12 hours, preferably up to 8 hours, more preferably up to 6, very preferably up to 4, and in particular up to 3 hours.

The substrates are coated by typical methods known to the skilled worker, with at least one coating composition being applied in the desired thickness to the substrate to be coated, and any volatile constituents of the coating composition being removed, if appropriate with heating. This operation may if desired be repeated one or more times. Application to the substrate may take place in a known way, as for example by spraying, troweling, knifecoating, brushing, rolling, rollercoating, flowcoating, laminating, injection backmolding or coextruding.

The thickness of a film of this kind for curing may be from 0.1 μm up to several mm, preferably from 1 to 2000 μm, more preferably 5 to 200 μm, very preferably from 5 to 60 μm (based on the coating material in the state in which the solvent has been removed from the coating material).

Additionally provided by the present invention are substrates coated with a multicoat paint system of the invention.

Polyurethane coating materials of this kind are especially suitable for applications requiring particularly high application reliability, exterior weathering resistance, optical qualities, solvent resistance, chemical resistance, and water resistance.

The two-component coating compositions and coating formulations obtained are suitable for coating substrates such as wood, wood veneer, paper, cardboard, paperboard, textile, film, leather, nonwoven, plastics surfaces, glass, ceramic, mineral building materials, such as molded cement blocks and fiber-cement slabs, or metals, which in each case may optionally have been precoated or pretreated.

Coating compositions of this kind are suitable as or in interior or exterior coatings, i.e., in those applications where there is exposure to daylight, preferably of parts of buildings, coatings on (large) vehicles and aircraft, and industrial applications, utility vehicles in agriculture and construction, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, such as in parking levels or in hospitals and in particular in automotive finishes, as OEM and refinish.

Coating compositions of this kind are used preferably at temperatures between ambient temperature to 80° C., preferably to 60° C., more preferably to 40° C. The articles in question are preferably those which cannot be cured at high temperatures, such as large machines, aircraft, large-capacity vehicles, and refinish applications.

In particular the coating compositions of the invention are used as clearcoat, basecoat, and topcoat material(s), primers, and surfacers.

It is an advantage of the polyisocyanate compositions of the invention that they maintain the color stability of polyisocyanate mixtures over a long time period in the presence of urethanization catalysts.

Polyisocyanate compositions of this kind can be employed as curing agents in coating materials, adhesives, and sealants.

By virtue of their low color number and high color stability they are of interest more particularly for coating compositions for clearcoat materials. Refinish applications are more particularly preferred.

### EXAMPLES

In the examples and the reference examples, the substances used were as follows:

### Polyisocyanates A

### Polyisocyanate A-1:

Polyisocyanate A-1 was prepared as follows:

1,6-hexamethylene diisocyanate from a phosgene process was stirred in the presence of 0.7% by weight of 2-ethylhexanol at a temperature of 95° C. for 90 minutes. Subsequently 65 ppm by weight of (2-hydroxypropyl)-N,N,N-trimethylammonium 2-ethylhexanoate were added as catalyst for the trimerization, and the batch was left to react at 65° C.

At an NCO value of 40.5% by weight of the reaction mixture, the reaction was discontinued by addition of 150 ppm by weight of 2-hydroxyethyl carbamate. The excess monomeric isocyanate was removed by vacuum distillation at 145° C. Measurement data of the pure compound: color number=23 Hz; NCO content=21.0%; viscosity=3100 mPa*s.

### Polyisocyanate A-2:

Polyisocyanate containing biuret groups, based on hexamethylene diisocyanate (Basonat® HB 100 from BASF AG)

### Catalysts B

Catalyst B-1: dibutyltin dilaurate (DBTL, DBTDL)

### Phosphonite C

Phosphonite C-1: tetrakis(2,4-di-tert-butylphenyl)-4,4′-diphenylene diphosphonite C (Irgafos® P-EPQ from Ciba Spezialitätenchemie) (purified by extraction by shaking in hexane against water, and subsequent drying over magnesium sulfate)

### Phenols D

Phenol D-1: benzenepropionoic acid, 3,5-bis(1,1-dimethylethyl)-4-hydroxy-C7-C9 branched alkyl ester (Irganox® 1135 from Ciba Spezialitätenchemie)

### Solvents E

Solvent E-1: solvent naphtha (boiling range about 170-180° C.)

Solvent E-2: n-butyl acetate

The polyisocyanates A were stored in about 50% by weight with the concentrations—indicated in the experiments—of catalysts (B), phosphonites (C), phenols (D), in each case 10% strength by weight in butyl acetate, and about 50% by weight of solvent (E) in tightly closed screw-top vessels under nitrogen, in order to exclude air. Traces of air cannot be excluded.

The % by weight figures are based on 100% total weight. The concentrations of the compounds (B), (C), and (D) in ppm are based, in the respectively undiluted state of the compounds (B) to (D), on the total amount of polyisocyanate (A).

Storage takes place in each case at 50° C. in a forced-air oven. The color numbers are measured directly (immediately before the beginning of storage), and after storage for different time periods.

Color number measurement takes place in APHA in accordance with DIN EN 1557 on a Lico 300 from Lange in a 5 cm cell with a volume of 5 ml. The error tolerances are as follows: for the target value 20 Hz (+/−5, actual value 18 Hz); target value 102 Hz (+/−10, actual value 99 Hz); target value 202 Hz (+/−20, actual value 197 Hz).

Each measurement was compared directly against a reference example (Ref) which was stabilizer-free.

TABLE 1
Experiments with 50% A-1, 1000 ppm of catalyst B-1 (DBTL),
and further components as per the table below, at 50° C.

| | Sol- | Phos- | | Color | Color | Color | Color |
|---|---|---|---|---|---|---|---|
| | vent | phonite | Phenol | number | number | number | number |
| | about | C-1 | D-1 | directly | 7 days | 56 days | 70 days |
| | 50% | ppm | ppm | Haze | Haze | Haze | Haze |
| Ref. 1 | E-1 | 0 | 0 | 13 | 67 | 113 | 141 |
| Ex. 1 | E-1 | 600 | 200 | 16 | 23 | 46 | 44 |
| Ref. 2 | E-2 | 0 | 0 | 10 | 29 | 50 | 53 |
| Ex. 2 | E-2 | 600 | 200 | 13 | 14 | 20 | 15 |

The results of the experiment show that the color drift in solvent naphtha is significantly more pronounced than in butyl acetate, and that the antioxidative stabilization by the compounds C-1 and D-1 is significant.

TABLE 2
Experiments with 50% of polyisocyanate A-2, 1000 ppm of catalyst B-1
(DBTL), 50% of solvent E-1, and further components
as per the table below, at 50° C.

| | | | Color | Color | Color | Color |
|---|---|---|---|---|---|---|
| | Phosphonite | Phenol | number | number | number | number |
| | C-1 | D-1 | directly | 7 days | 49 days | 70 days |
| | ppm | ppm | Haze | Haze | Haze | Haze |
| Ref. 3 | 0 | 0 | 11 | 109 | 316 | 360 |
| Ex. 3 | 600 | 200 | 14 | 43 | 77 | 82 |

The results of the experiments show that the antioxidative stabilization by compounds C-1 and D-1 is significant.

1-20. (canceled)

21. A polyisocyanate composition comprising
(A) at least one polyisocyanate obtainable by reacting at least one monomeric (cyclo)aliphatic isocyanate,
(B) at least one compound able to accelerate the reaction of isocyanate groups with isocyanate-reactive groups,
(C) at least one phosphonite, and
(D) at least one sterically hindered phenol, which contains per aromatic ring just one phenolic hydroxy group and in which at least one ortho-position relative to the functional group has a tert-butyl group.

22. The polyisocyanate composition according to claim 21, wherein the monomeric (cyclo)aliphatic isocyanate is selected from the group consisting of 1,6-hexamethylene diisocyanate, 1,3-bis(isocyanatomethyl)cyclohexane, isophorone diisocyanate, 4,4′-di(isocyanatocyclohexyl)methane, and 2,4′-di(isocyanatocyclo-hexyl)methane.

23. The polyisocyanate composition according to claim 21, wherein the polyisocyanate (A) comprises at least one of isocyanurate, biuret, urethane, allophanate and iminooxadiazinedione groups.

24. The polyisocyanate composition according to claim 21, wherein the polyisocyanate is a polyisocyanate comprising isocyanurate groups having a viscosity of 600-1500 mPa*s, a low-viscosity urethane, allophanate, or a combination thereof having a viscosity of 200-1600 mPa*s.

25. The polyisocyanate composition according to claim 21, wherein the compound (B) is a Lewis-acidic organometallic compound.

26. The polyisocyanate composition according to claim 25, wherein the Lewis-acidic organometallic compound comprises a metal selected from the group consisting of tin, zinc, iron, titanium, aluminum, zirconium, manganese, nickel, cobalt, bismuth and caesium.

27. The polyisocyanate composition according to claim 21, wherein compound (C) is a phosphonite of the formula
P(OR¹)(OR²)(R³),
in which
each of R¹, R², and R³ is independently, C₁-C₁₈-alkyl, C₆-C₁₂-aryl, and C₅-C₁₂ cycloalkyl, each optionally substituted by at least one of aryl, alkyl, aryloxy, alkyloxy, heteroatoms and heterocycles,
and said phosphonite is optionally monocyclic or polycyclic.

28. The polyisocyanate composition according to claim 27, wherein compound (C) is a phosphonite of the formula 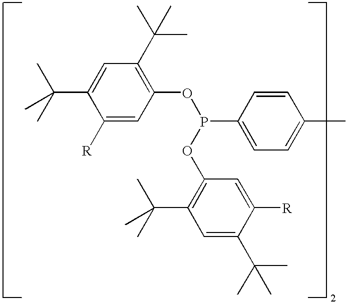
in which R can be hydrogen or methyl.

29. The polyisocyanate composition according to claim 21, wherein the compound (D) is 2,6-bis-tert-butyl-4-methylphenol or 3,5-bis(1,1-dimethylethyl)-4-hydroxy-C7-C9 branched alkyl ester of benzenepropionic acid.

30. The polyisocyanate composition according to claim 21, further comprising at least one solvent (E) selected from the group consisting of an aromatic hydrocarbon, a (cyclo)aliphatic hydrocarbon, a ketone, an ester, an ether, and a carbonate.

31. The polyisocyanate composition according to claim 21, wherein the polyisocyanate composition, after seven-week storage at 50° C., exhibits not more than 30% of the increase in color number, as described by a APHA color number in accordance with DIN EN 1557, of similar polyisocyanate compositions in which neither a component (C) nor a component (D) is present.

32. A method of stabilizing a polyisocyanate composition comprising polyisocyanate (A) and at least one compound (B) which is able to accelerate the reaction of isocyanate groups with isocyanate-reactive groups, which comprises admixing the polyisocyanate composition additionally with at least one phosphonite (C), and at least one phenol (D).

33. A process for preparing a polyurethane coating material, which comprises reacting a polyisocyanate composition according to claim 21 with at least one binder start which contains isocyanate-reactive groups.

34. A process for preparing a polyurethane coating material, which comprises reacting a polyisocyanate composition according to claim 21 with at least one binder selected from the group consisting of polyacrylate polyols, polyester polyols, polyether polyols, polyurethane polyols, polyurea polyols, polyetherols, polycarbonates, polyester-polyacrylate polyols, polyester-polyurethane polyols, polyurethane-polyacrylate polyols, polyurethane-modified alkyd resins, fatty acid-modified polyester-polyurethane polyols, copolymers with allyl ethers, and copolymers and graft polymers of the stated groups of compounds.

35. A process for preparing a polyurethane coating material, which comprises mixing at least one polyisocyanate first with at least one compound (B) which is able to accelerate the reaction of isocyanate groups with isocyanate-reactive groups, at least one phosphonite (C), at least one phenol and (D) subsequently applying the mixture to the substrate and curing it.

36. The polyisocyanate composition according to claim 21, further comprising at least one of
at least one acidic stabilizer, and
a further coating additive.

37. The polyisocyanate composition according to claim 25, wherein the Lewis-acidic organometallic compound comprises a metal selected from the group consisting tin and zinc.

38. The polyisocyanate composition according to claim 21, further comprising at least one solvent (E) selected from the group consisting of a distillation cut of aromatic hydrocarbons and a dialkyl ketone, wherein said distillation cut of aromatic hydrocarbons has C₉ and C₁₀ aromatic hydrocarbons as a main component.

39. The method according to claim 32, further comprising admixing at least one solvent (E), at least one further coating additive (F), or a combination thereof.
